(19) United States
(12) Patent Application Publication
(10) Pub. No.: US 2018/0130982 A1
(43) Pub. Date: May 10, 2018

(54) BATTERY MODULE WITH A PLURALITY OF BATTERY CELLS, AND BATTERY

(71) Applicant: Robert Bosch GmbH, Stuttgart (DE)

(72) Inventors: Christoph Schlund, Bamberg (DE); Florian Postler, Schesslitz (DE); Steffen Schoenfeld, Stuttgart (DE); Timo Kegel, Memmelsdorf (DE)

(21) Appl. No.: 15/805,164

(22) Filed: Nov. 7, 2017

(30) Foreign Application Priority Data
Nov. 8, 2016 (DE) 10 2016 221 817.4

(51) Int. Cl. H01M 2/10; H01M 10/653; H01M 10/613; H01M 10/6551; H01M 10/659; H01M 10/647; H01M 10/6556

(52) U.S. Cl. CPC H01M 2/1077; H01M 10/653; H01M 10/613; H01M 2220/20; H01M 10/659; H01M 10/647; H01M 10/6556; H01M 10/6551

(57) ABSTRACT

A battery module having a plurality of battery cells (2), which are mutually electrically interconnected in series or in parallel. The battery cells (2) are arranged side by side in a longitudinal direction (5) and, in combination, constitute at least a first outer surface (6) and a second outer surface (7). The battery module (1) further comprises a first clamping plate (3) and a second clamping plate (4), and the first clamping plate (3) is arranged on the first outer side (6), and the second clamping plate (4) is arranged on the second outer side (7). A first adhesive layer (8) is arranged between the first clamping plate (3) and the first outer side (6), a second adhesive layer (9) is arranged between the second clamping plate (4) and the second outer side (7).

### BACKGROUND OF THE INVENTION

The invention relates to a battery module having a plurality of generic battery cells. A further object of the present invention is a battery having such a battery module.

From the prior art, it is known that batteries, for example of an electric or hybrid vehicle such as, specifically, lithium-ion batteries, are comprised at least of a battery module or, advantageously, of a plurality of battery cells. Furthermore, a battery module is moreover preferably comprised of a plurality of individual battery cells, which are mutually interconnected to form a battery module. To this end, the individual battery cells can be mutually electrically interconnected, in series or in parallel.

Ageing processes associated with charging and discharging cycles in the individual battery cells generate internal forces, as a result of which the individual battery cells do not maintain a constant shape during their service life, but rather these processes, described as distension, generate strain in the housing of the battery cells. These processes thus dictate the adoption of a battery module design which can accommodate the internal forces associated with ageing processes, and can limit the deformation of the housings of the individual battery cells. The loading of the individual battery cells, or the housing thereof, with a force, in the interests of limiting deformation, is generally described as compression.

Document DE 10 2013 206 504 A1 discloses a battery module having at least two adjacently arranged battery cells, wherein a base of at least one of the battery cells is provided with a thermally-conductive leveling coating, which compensates an offset between the battery cells.

Document DE 10 2010 055 600 A1 further discloses a device for the cooling of a battery comprised of a plurality of individual battery cells, wherein the device comprises at least one latent heat accumulator incorporating a phase change material. The device further comprises heat-conducting elements, one end of which is in thermally-conductive contact with the individual battery cells, and the other end of which is in contact with the latent heat accumulator arranged in the vicinity of the assembly of the individual battery cells.

### SUMMARY OF THE INVENTION

The battery module with a plurality of battery cells according to the invention has an advantage, in that it permits the reliable mechanical attachment and compression of the plurality of battery cells in the battery module. In consequence, the overall number of components required for the battery module can be reduced, thereby permitting a simpler and more cost-effective design, and simultaneously increasing both the volumetric and the gravimetric energy density of the battery module.

According to the invention, a battery module is disclosed having a plurality of battery cells. The battery cells are mutually electrically interconnected in series or in parallel, and are moreover arranged side by side in a longitudinal direction of the battery module. The battery cells further constitute, in combination, at least a first outer surface and, in combination, at least a second outer surface. The battery module further comprises a first clamping plate and a second clamping plate. The first clamping plate is arranged on the first outer side, and the second clamping plate is arranged on the second outer side.

A first adhesive layer is arranged between the first clamping plate and the first outer side, and a second adhesive layer is arranged between the second clamping plate and the second outer side.

By the combined configuration of the first outer surface and the second outer surface by the plurality of battery cells, it is to be understood that the first outer surface and/or the second outer surface respectively are configured by the combination of at least two battery cells. It is entirely possible that the battery cells which form the first outer side are different from the battery cells which form the second outer side.

It is further preferred if the totality of the plurality of battery cells, in combination, respectively form the first outer side and the second outer side, wherein each battery cell of the plurality of battery cells respectively thus forms a region of the first outer surface and a region of the second outer surface.

Specifically, it is advantageous if the first outer surface and the second outer surface are arranged in parallel with the longitudinal direction of the battery module, such that the normal vectors of the respective outer surface are essentially arranged perpendicularly to the longitudinal direction of the battery module.

A first or second clamping plate is to be understood as a dimensionally stable mechanical component which, during the operation of the battery module and in response to the resulting forces acting on the respective clamping plate, essentially undergoes no strain and thus maintains a constant shape, such that a sufficient overall mechanical stability of the battery module can be achieved. The first clamping plate and/or the second clamping plate can preferably be configured of metal, such as, for example, aluminum, or can also be configured of plastic.

Advantageously, each of the battery cells comprises a battery cell housing of prismatic design. By a battery cell housing of prismatic design, it is to be understood that the battery cell housing has six lateral surfaces, wherein opposing lateral surfaces are essentially configured in a mutually parallel arrangement, and adjoining lateral surfaces are essentially configured at right angles to each other. Opposing lateral surfaces are moreover of essentially the same shape. It should be observed that, as a result of the aforementioned ageing processes, the battery cell housing does not maintain a constant shape over its service life, whereby the battery cell housing is essentially configured with a prismatic design. In the respective battery cell housings of prismatic design, the electrochemical components of the respective battery cells are arranged, such as, for example, the anode, the cathode, the separator and the electrolyte. The battery cells are moreover arranged side by side in the longitudinal direction of the battery module, such that the largest lateral surfaces of the battery cell housings are respectively configured in a directly mutually adjoining arrangement. This has an advantage, in that it permits a reliable mechanical attachment and compression of the plurality of battery cells in a battery cell housing of prismatic design, as the strain associated with ageing processes is predominantly respectively assumed by the largest lateral surfaces of the battery cells. Consequently, by means of the arrangement of the first clamping plate or the second clamping plate on the first outer side or the second outer side respectively, which are configured by the lateral surfaces of the smallest size or of intermediate size, strain is counteracted overall, and the mechanical stability of the battery cell housing is employed for the configuration of a mechanically stable structure for the battery module. Overall, it is thus also possible to reduce the total height of the battery module.

In a particularly preferred form of embodiment of the battery module, the individual battery cells are configured such that the battery cell housings are essentially comprised of one first half-shell-shaped battery cell housing half, and of one second half-shell-shaped battery cell housing half, wherein the first half of the battery cell housing constitutes a positive voltage tap, and the second half of the battery cell housing constitutes a negative voltage tap such that, by the alternating arrangement of battery cells, a series circuit can be configured. Such battery cells are known as half-shell battery cells, and are also described as “nutshell” battery cells.

Appropriately, the first outer side and the second outer side are arranged in mutual opposition, wherein the first outer side and the second outer side are specifically configured in a mutually parallel arrangement. By this arrangement, even in the event of rising strain forces, the first clamping plate and the second clamping plate can reliably secure and compress the plurality of battery cells.

According to an advantageous further development, the battery module further comprises a first end plate and a second end plate. The first end plate is arranged in the longitudinal direction of the battery module, at a first end thereof, and the second end plate of the battery module is arranged at a second end of the battery module, opposite the first end. At this point, it will be observed that, in the preferred configuration of the battery cells with a prismatic battery cell housing, the first end plate and the second end plate respectively are arranged on the largest lateral surfaces of the battery cells directly adjoining the first end plate or the second end plate. Moreover, the first outer surface and the second outer surface are preferably arranged in parallel with the longitudinal direction. The arrangement of the first end plate and the second end plate has an advantage, in that an additional compressive force can thus be applied to the plurality of battery cells in the battery module, thereby specifically limiting the strain of the largest lateral surfaces in the direction of the longitudinal direction of the battery module.

It is advantageous if the first clamping plate and/or the second clamping plate are additionally configured as cooling elements for the battery module. To this end, the first clamping plate and/or the second clamping plate can incorporate channels, which are configured for the flow of a coolant fluid therein. To this end, the first clamping plate and the second clamping plate can moreover comprise a phase change material. It is moreover possible that, to this end, the first clamping plate or the second clamping plate comprise cooling ribs, which are preferably arranged on the side of the first clamping plate or of the second clamping plate which is averted from the plurality of battery cells. This has an advantage in that, by the arrangement of the first or the second adhesive layer between the first outer side or the second outer side and the first clamping plate or the second clamping plate, which is configured as a cooling element, a defined and reliable bonding of the cooling element with the highest possible heat transfer coefficient can be achieved, as the incorporation of air can specifically be prevented.

According to a further aspect of the invention, the battery module can also comprise a plurality of first clamping plates and/or a plurality of second clamping plates. This has an advantage, in that it permits reliable mechanical fixing, specifically in the event of a larger number of battery cells.

Preferably, the first adhesive layer and/or the second adhesive layer are comprised of an electrically insulating material, wherein an electrically insulating material is specifically to be understood as a material having a high specific resistance, preferably greater than 10¹² Ω mm² m⁻¹. It is further preferred if the first adhesive layer and/or the second adhesive layer are comprised of a thermally conductive material, preferably having a thermal conductivity greater than 1 W m⁻¹ K⁻¹. Specifically, the first or the second adhesive layer can further incorporate additives for increasing the thermal conductivity.

The first adhesive layer and/or the second adhesive layer can thus be specifically configured, for example, as a film or as a multi-layered film.

According to a further aspect of the invention, the first adhesive layer and/or the second adhesive layer comprise an elastic component and/or a plastic component. As a result, manufacturing tolerances between the individual battery cells, and the strain of individual battery cells, can be compensated, thus permitting the reduction of the generation of insufficient compressive forces between the battery cells and the first or second clamping plate, and also preventing the generation of excessively high compressive forces. Specifically, by this arrangement, a reliable bond to a first or second clamping plate of the battery module, configured as a cooling element, can be configured with a higher coefficient of thermal conductivity.

It is also appropriate if cell connectors are arranged on a third outer surface which is formed by the combination of battery cells and is arranged directly adjacently to the first outer surface. The cell connectors are configured to form a series or parallel electric circuit arrangement of the individual battery cells. This has an advantage, in that the cell connectors can also be positioned after the arrangement of the first clamping plate and the second clamping plate, and will remain accessible. Specifically, the battery cells incorporate a battery cell housing of prismatic design.

According to a further aspect of the invention, directly mutually adjoining battery cells are configured with a mutual clearance. To this end, preferably, a respective compensating element can be arranged between the directly mutually adjoining battery cells, which compensating element can incorporate an elastic component and/or a plastic component. By this arrangement, strain forces associated with ageing processes in the battery cells can be accommodated by the compensating element. Naturally, it is also possible for no compensating element to be arranged between the mutually spaced battery cells, whereby, as a result of the clearance between the battery cells, the limited strain thereof is permitted.

The invention further relates to a battery having a battery module according to the invention, of the type just described.

### BRIEF DESCRIPTION OF THE DRAWINGS

Exemplary embodiments of the invention are represented in the drawings, and are described in greater detail in the following description.

FIG. 1 shows a perspective view of one form of embodiment of a battery module according to the invention, and

FIG. 2 shows a perspective view of a further form of embodiment of a battery module according to the invention.

### DETAILED DESCRIPTION

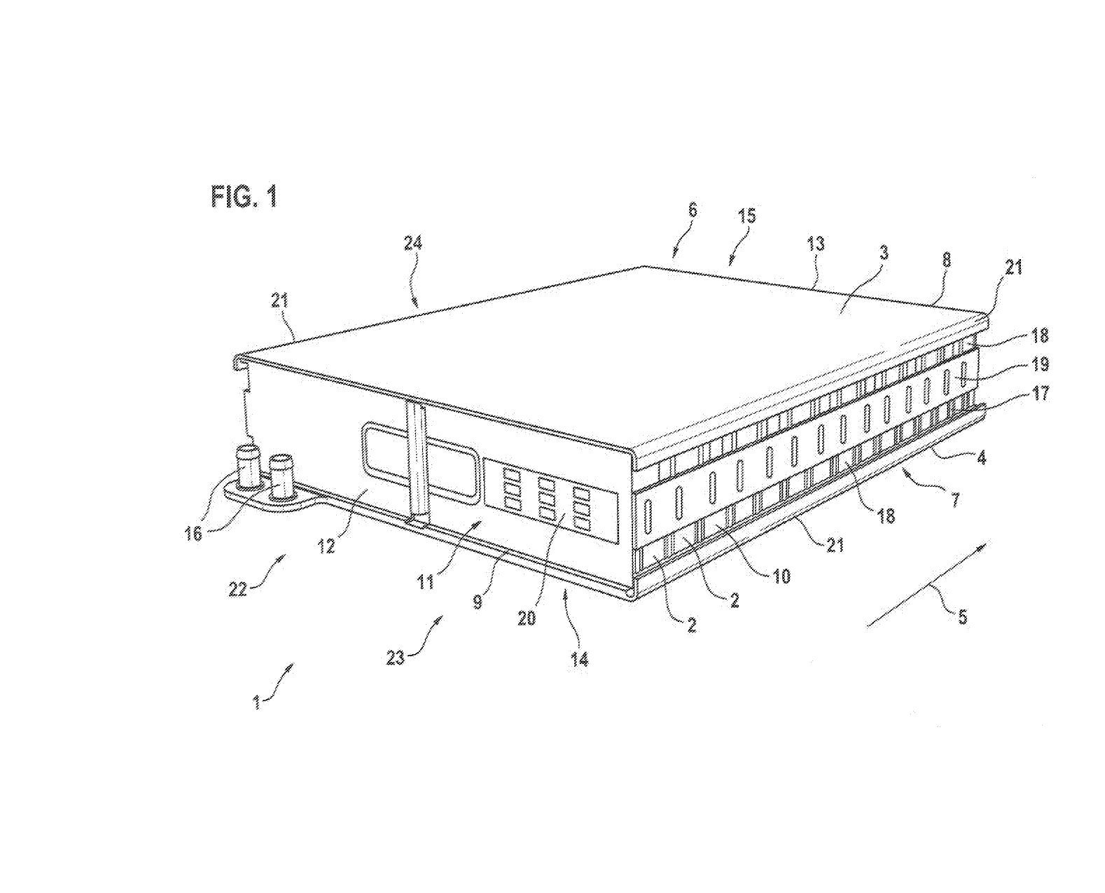

FIG. 1 shows a schematic representation of a perspective view of one form of embodiment of a battery module 1 according to the invention, having a plurality of battery cells 2.

The plurality of battery cells 2 are arranged side by side in a longitudinal direction 5 of the battery module 1.

The battery cells 2 thus constitute, in combination, a first outer side 6, which specifically can also be described as an upper side of the battery module 1, and a second outer side 7, which specifically can also be described as an underside of the battery module 1. Specifically, in the form of embodiment of the battery module 1 illustrated in FIG. 1, all the battery cells 2, in combination, constitute the first outer side 6 and the second outer side 7.

The battery module 1 moreover comprises a first clamping plate 3 and a second clamping plate 4.

As indicated in FIG. 1, the first clamping plate 3 is arranged on the first outer side 6, and the second clamping plate 4 is arranged on the second outer side 7. A first adhesive layer 8 is arranged in this case between the first clamping plate 3 and the first outer side 6, and a second adhesive layer 9 is arranged between the second clamping plate 4 and the second outer side 7.

According to the exemplary embodiments represented in FIG. 1, the battery cells 2 each comprise a battery cell housing 10 of prismatic design, in which the electrochemical components of the respective battery cell 2 are arranged. FIG. 1 further indicates that the battery cells 2 are arranged side by side in the longitudinal direction 5 of the battery module 1, such that the largest lateral surfaces 11 of the battery cell housings 10 are respectively arranged directly adjacently to each other. At this point, it will be observed that the battery module 1 comprises two rows 22, 23 of identical battery cells 2, wherein the two rows 22, 23 are arranged side by side in the longitudinal direction 5.

From FIG. 1, it will further be seen that the first outer side 6 and the second outer side 7 are configured in a mutually opposing arrangement.

The battery module 1 further also comprises a first end plate 12, and a second end plate 13, which cannot be seen in FIG. 1. The first end plate 12, in the longitudinal direction 5 of the battery module 1, is arranged in this case at a first end 14 of the battery module 1, and the second end plate 13 of the battery module 1 is arranged at a second end 15 of the battery module 1, opposite the first end 14. The first end plate 12 and the second end plate 13 respectively are preferably arranged on the largest lateral surfaces 11 of the battery cells 2 directly adjoining the first end plate 12 and the second end plate 13 respectively, and preferably cover said surfaces in an essentially complete manner.

The second clamping plate 4 of the battery module 1 is moreover configured as a cooling element, wherein the second clamping plate 4 preferably incorporates channels for this purpose, which are configured to accommodate a flow of coolant fluid therein. By means of the connections 16 represented, coolant fluid can be admitted to or discharged from the channels.

The battery cells 2, in combination, moreover form a third outer side 17, which is preferably arranged directly adjacently to the first outer side 6, and is preferably also arranged directly adjacently to the second outer side 7. Cell connectors 18 are arranged in this case on the third outer side 17, which are configured for mutual interconnection to form series and/or parallel electric circuit arrangements of the battery cells 2. Furthermore, a cell bonding system 19 can also be arranged on the third outer side 17, which system is configured for the monitoring of functions of the battery cells 2, specifically including temperatures or voltages thereof.

It is moreover possible that the first end plate 12 incorporates a control and/or regulation unit 20 of the battery module 1.

From FIG. 1, it can also be seen that the first clamping plate 3 or the second clamping plate 4, on opposing sides, can respectively each be configured with a corner radius 21, which can also be arranged, at least partially, on the third outer side 17, and also on an outer side 24 arranged opposite the third outer side 17.

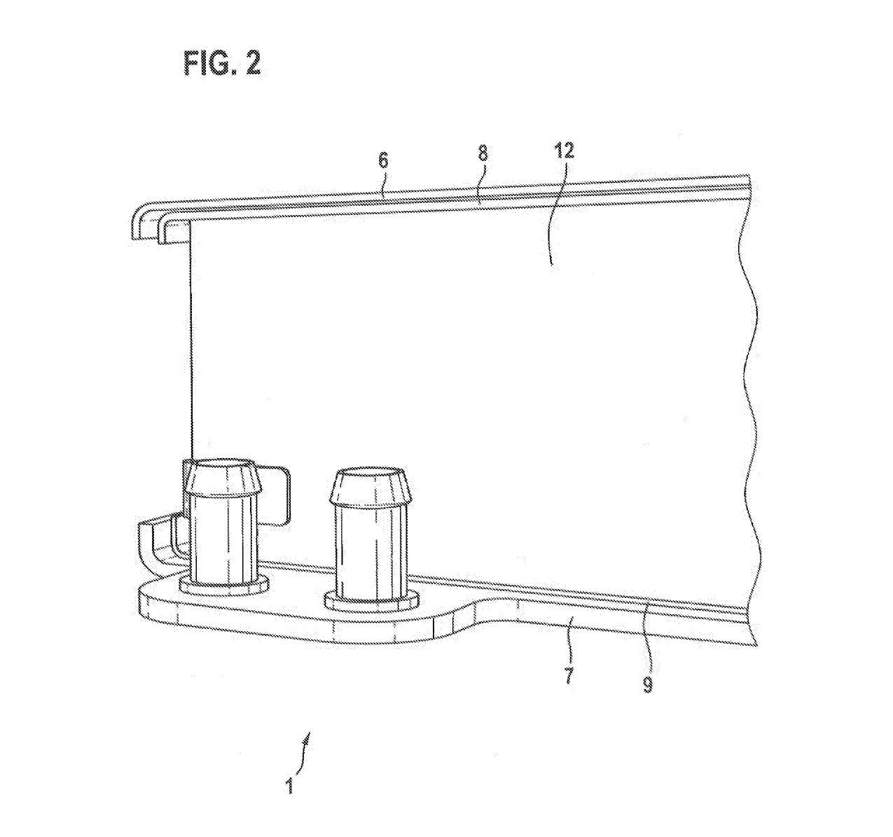

FIG. 2 shows a schematic representation of a perspective view of a further battery module 1 according to the invention.

Herein, specifically, the first end plate 12 is represented. The first clamping plate 6 and the second clamping plate 7, which is preferably configured as a cooling element of the battery module 1, can furthermore also be seen.

According to the exemplary embodiment of the battery module 1 represented in FIG. 2, the first adhesive layer 8, which is arranged between the first clamping plate 3 and the first outer side 6, incorporates an elastic component and/or a plastic component. The function of the elastic component and/or the plastic component is the compensation of tolerances in the arrangement of the individual battery cells 2. Naturally, the second adhesive layer 9 can also incorporate an elastic component and/or a plastic component.

It is further preferred if the second adhesive layer 9 is comprised of a thermally conductive material, by means of which high thermal conductivity can be achieved between the plurality of battery cells 2 and the lower clamping plate 7, configured as a cooling element.

Preferably, the first adhesive layer 8 and/or the second adhesive layer 9 are also comprised of an electrically insulating material, in the interests of improving safety.

1. A battery module comprising a plurality of battery cells (2) which are mutually electrically interconnected in series or in parallel, wherein the battery cells (2) are arranged side by side in a longitudinal direction (5) of the battery module (1) and, in combination, constitute at least a first outer surface (6) and a second outer surface (7), wherein the battery module (1) further comprises a first clamping plate (3) and a second clamping plate (4), wherein the first clamping plate (3) is arranged on the first outer side (6), and the second clamping plate (4) is arranged on the second outer side (7), wherein a first adhesive layer (8) is arranged between the first clamping plate (3) and the first outer side (6), and wherein a second adhesive layer (9) is arranged between the second clamping plate (4) and the second outer side (7).

2. The battery module according to the preceding claim 1, wherein each of the battery cells (2) comprises a battery cell housing (10) of prismatic design, in which the electrochemical components of the respective battery cells (2) are arranged, and the battery cells (2) are arranged side by side in the longitudinal direction (5) of the battery module (1), such that the largest lateral surfaces (11) of the battery cell housings (10) are respectively configured in a directly mutually adjoining arrangement.

3. The battery module according to claim 1, characterized in that the first outer side (6) and the second outer side (7) are arranged in mutual opposition.

4. The battery module according to claim 1, characterized in that the battery module (1) further comprises a first end plate (12) and a second end plate (13), wherein the first end plate (12) is arranged in the longitudinal direction (5) of the battery module (1), at a first end (14) thereof, and the second end plate (13) of the battery module (1) is arranged at a second end (15) of the battery module (1), opposite the first end (14).

5. The battery module according to claim 1, characterized in that the first clamping plate (3) and/or the second clamping plate (4) comprise channels which are configured for the flow of a coolant fluid therein.

6. The battery module according to claim 1, characterized in that the first clamping plate and/or the second clamping plate comprise a phase change material.

7. The battery module according to claim 1, characterized in that the first clamping plate and/or the second clamping plate comprise cooling ribs.

8. The battery module according to claim 1, characterized in that the battery module (1) comprises a plurality of first clamping plates (3) and/or a plurality of second clamping plates (4).

9. The battery module according to claim 1, characterized in that the first adhesive layer (8) and/or the second adhesive layer (9) are comprised of an electrically insulating material and/or of a thermally conductive material, and wherein the first adhesive layer (8) and/or the second adhesive layer (9) are specifically configured as a film or as a multi-layered film.

10. The battery module according to claim 1, characterized in that the first adhesive layer (8) and/or the second adhesive layer (9) comprise an elastic component and/or a plastic component.

11. The battery module according to claim 1, wherein cell connectors (18) are arranged on a third outer surface (17) which is formed by the combination of battery cells (2) and is arranged directly adjacently to the first outer surface (6), and configured to form a series or parallel electric circuit arrangement.

12. The battery module according to claim 1, characterized in that directly mutually adjoining battery cells (2) are configured with a mutual clearance, and

13. The battery module according to claim 12, wherein a respective compensating element is arranged between directly mutually adjoining battery cells (2).

14. A battery having a battery module (1) according to claim 1.
